(19) United States
(12) Patent Application Publication
(10) Pub. No.: US 2009/0157800 A1
(43) Pub. Date: Jun. 18, 2009

(54) Dynamically Generating a Proxy Object in a Client for Dynamically Created Object on the Server Using Retrieved Class Metadata of the Object

(76) Inventors: Cheng-Chieh Cheng, Rochester, MN (US); Teresa Chung Kan, Rochester, MN (US); Kevin William Sutter, Rochester, MN (US); Jian Tang, Rochester, MN (US)

Correspondence Address: WOOD, HERRON & EVANS, L.L.P. (IBM), 2700 CAREW TOWER, 441 VINE STREET, CINCINNATI, OH, 45202, US

(21) Appl. No.: 11/958,696

(22) Filed: Dec. 18, 2007

(51) Int. Cl. G06F 15/16

(52) U.S. Cl. 709/203

(57) ABSTRACT

A method, apparatus and program product retrieve, in the client, class metadata of an object that is used by the computer program from a remote service, including retrieving object type data of the object, and dynamically generate on the client a proxy object for the object on the server. The object is dynamically created and resides on a server, and the type of the object is unknown to the computer program prior to retrieval of the class metadata. Furthermore, casting a type of the proxy object to a type that is specific to an interface known to the computer program without receiving any class cast exception. By doing so, the dynamically created proxy object may be utilized for remote method invocation in a distributed environment utilizing objects dynamically created on the server, often avoiding a costly deployment process and independent of any protocols.

### FIELD OF THE INVENTION

The invention relates to computers and computer software, and in particular, to invoking methods of objects on a server.

### BACKGROUND OF THE INVENTION

Many modern computer systems include clients and servers. The client-server concept is a type of distributed network architecture, which enables a client to make a request to a server. The client is often a single user computer or a program running on the same, while the server is often a multi-user computer or a program running on the same. After receiving the request, the server (e.g., an application server) will process the request and typically generate a response back to the client. A server is typically located remotely from a client and can process requests from multiple clients.

The terms client and server may also relate to two computer processes that are in communication with each other, where one client process typically makes a request for information and the server process returns a response with the desired information. Once the client process connects to the server process via an established connection, both the client and server computers can use this connection to communicate data until the connection is closed.

Due to the wide availability of networked computers utilizing clients and servers, distributed applications or client-server applications have become commonplace. Distributed applications may take the form of a two tier setup with a client and a server, or a three tier setup, with middleware (or middleware layer) between the client and server. Distributed applications are often object-oriented computer programs created using a set of language tools, abstractions and constructs that support a particular form of user-defined type called a “class”. A class functions as a template, and associates a collection of declared data with a set of operations capable of being performed on that data (i.e., methods capable of being called on the data).

To achieve this object-oriented design, the distributed application may be created using an object-oriented programming language such as JAVA. Specifically, the distributed application is first written in JAVA, compiled by a compiler to a format suitable for execution in a runtime environment. After compilation, deployment code may be generated and the distributed application may be deployed or installed in the runtime environment. Next, the application is executed during runtime in the runtime environment such as in a JAVA virtual machine (JVM). The deployment process generally happens before runtime because what is deployed is what gets executed in the JVM. In particular, a portion of the distributed application may be compiled and run in the client and a portion of the application may be compiled and run in the server. As such, the client may have its own runtime environment (e.g., client JVM) and the server may have its own runtime environment (e.g., server JVM).

Typically, in object-oriented programming, objects are dynamically created during runtime. The objects are created using the classes as templates in the server runtime environment by the server process during server runtime. The creation of a new object is often referred to as “instantiation,” whereby an object is an “instance” of a class. The class associated with an object will define the type of the object or object type. One or more distributed applications may cause objects to be dynamically created on the server, although some objects may be installed on a server.

As objects are often located on servers, the client-side of an application will typically seek to invoke the methods of the objects on the servers, which is referred to remote method invocation. When the type of an object on the server is known, client code and server code is typically generated during compile time to facilitate remote method invocation. As a first example, the compiler may be used to generate client stub code and server skeleton code (e.g., as a static pre-build step). The client stub is client-side code operates as a “proxy” for the object and allows the client to interact with the object on the server as if the object on the server resided on the client. The client stub may have the same interface as the object on the server and translates the method invocation, but does not directly implement the object's methods. The server skeleton code is server-side code that implements the object's methods. As a second example, the deployment process is utilized to generate the client stub and the server skeleton code.

However, the type of objects on a server (e.g., objects that are dynamically generated on a server) may not always be known. For instance, the object may have been dynamically created by a different distributed application. The type of the object may not be known until after the object is dynamically created during server runtime. And, if the object type is unknown to the compiler during compilation, server code (and client code) cannot be generated during compilation. The conventional techniques for enabling clients to access dynamically created objects resident on a server have generally been inadequate and inefficient. In particular, traditional proxy generation mechanisms have relied on client stubs and server skeleton code, either at compile time or during deployment, both of which occur before runtime (i.e., before the object type of the object created on the server is known). As such, techniques based on older and static computing models may be inadequate for newer computing models where objects are dynamically created.

Other techniques also have drawbacks. For example, one technique, which focuses on a runtime client-side invocation of methods and server-side skeleton generation, relies on a delayed deployment process (e.g., to generate the server-side skeleton) that occurs during runtime. However, deployment processes are generally costly operations that negatively affect the performance of the application. Moreover, deployment processes typically utilize one or a few protocols. As such, this technique is protocol dependent, which limits its applicability.

Furthermore, although some proxy generation mechanisms have been utilized to create a proxy that is tied to a local object, such as creating a local proxy for a managed object, these proxy generation mechanisms have generally been directed towards non-distributed environments, such as a single JVM environment. Thus, these mechanisms do not support many of the complexities discussed above between clients and servers, and are generally not suitable for distributed environments, such as multi-JVM environments.

Despite the unknown type of objects, it may be advantageous, however, for an application to have a handle that is known to the application, such as a handle that is compatible to the interface of the object with the unknown type. As such, creating a handle that is specific to an application may be desirable, especially as distributed computing technology continues to evolve.

A need therefore exists to implement remote method invocation on objects of unknown type, in particular, an improved manner of invoking methods of objects that are dynamically created on a server and are of a type that is not known before runtime by a client, which may be utilized in distributed environments. As such method can avoid exceptions such as ClassCastException when a handle is casted to a type that is specific to an interface known to the computer program.

### BRIEF SUMMARY OF THE INVENTION

The invention addresses these and other problems associated with the prior art by providing an apparatus, a program product, and a method that retrieve, in the client, class metadata of an object that is used by the computer program from a remote service, including retrieving object type data of the object, and dynamically generate on the client a proxy object for the object on the server. The object is dynamically created and resides on a server, and the type of the object is unknown to the computer program prior to retrieval of the class metadata. By doing so, the dynamically created proxy object may be utilized for remote method invocation in a distributed environment utilizing objects dynamically created on the server, often avoiding a costly deployment process and reliance on specific protocols.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described exemplary embodiments of the invention.

### BRIEF DESCRIPTION OF THE SEVERAL VIEWS OF THE DRAWINGS

FIG. 1 is a block diagram of a client-server computer system incorporating dynamic proxy object generation consistent with the invention.

FIG. 2 is an expanded view of the block diagram of FIG. 1 during runtime and prior to dynamic proxy object generation.

FIG. 3 is an expanded view of the block diagram of FIG. 2 during runtime and after dynamic proxy object generation.

FIG. 4 is a flowchart illustrating an exemplary dynamic proxy object generation routine executed in the client-server computer system of FIG. 1.

FIG. 5 is a flowchart illustrating an exemplary remote method invocation routine executed in the client-server computer system of FIG. 1.

FIG. 6 is a diagram of exemplary routing code referenced in FIG. 4 and FIG. 5.

FIG. 7 is a block diagram illustrating an example of dynamic proxy object generation consistent with the invention.

FIG. 8 is a block diagram illustrating an example of remote method invocation consistent with the invention.

### DETAILED DESCRIPTION OF THE INVENTION

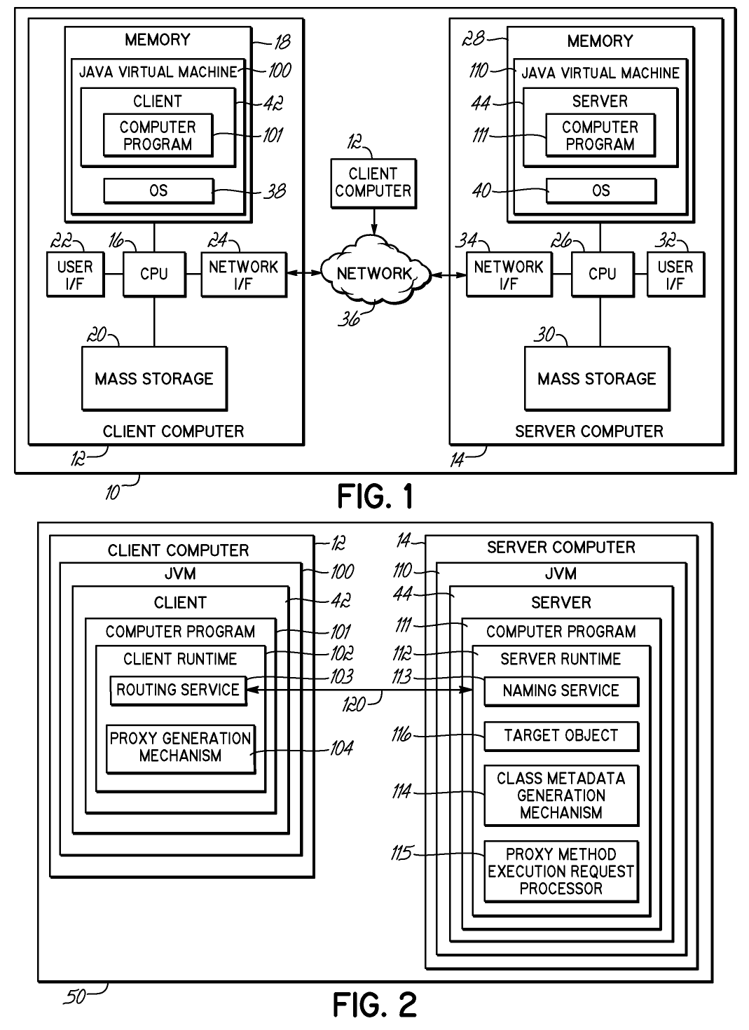

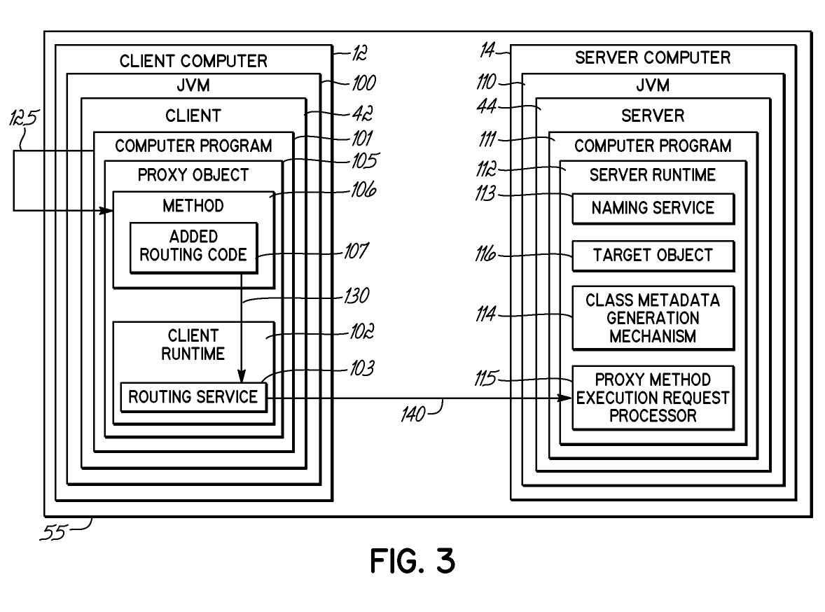

Turning now to the Drawings, wherein like numbers denote like parts throughout the several views, FIG. 1 illustrates a client-server based computer system or environment 10 incorporating dynamic proxy object generation consistent with the invention. FIG. 2 illustrates an expanded view of system 10 prior to dynamic proxy object generation. FIG. 3 illustrates an expanded view of system 10, as illustrated in FIG. 2, after dynamic proxy object generation.

Referring to FIG. 1, the client-server computer system 10 includes at least one apparatus, e.g., one or more client computers 12 and one or more server computers 14. For the purposes of the invention, each computer 12, 14 may represent practically any type of computer, computer system or other programmable electronic device capable of functioning as a client and/or server in a client-server environment. Moreover, each computer 12, 14 may be implemented using one or more networked computers, e.g., in a cluster or other distributed computing system. Moreover, as is common in many client-server systems, typically multiple client computers 12 will be interfaced with a given server computer 14. Client-server environments as well as peer-to-peer environments, where each peer computer acts as a client computer 12 and/or a server computer 14, are contemplated within the scope of the present invention.

Computer 12 typically includes a central processing unit 16 including at least one microprocessor coupled to a memory 18, which may represent the random access memory (RAM) devices comprising the main storage of computer 12, as well as any supplemental levels of memory, e.g., cache memories, non-volatile or backup memories (e.g., programmable or flash memories), read-only memories, etc. In addition, memory 18 may be considered to include memory storage physically located elsewhere in computer 12, e.g., any cache memory in a processor in CPU 16, as well as any storage capacity used as a virtual memory, e.g., as stored on a mass storage device 20 or on another computer coupled to computer 12. A runtime environment is resident in memory 18, for example, taking the form of a JAVA Virtual Machine (JVM) 100, including a client 42, within which executes a computer program or application (e.g., computer program 101). Computer program 101 or application 101 may be Java based. Computer 12 also typically receives a number of inputs and outputs for communicating information externally. For interface with a user or operator, computer 12 typically includes a user interface 22 incorporating one or more user input devices (e.g., a keyboard, a mouse, a trackball, a joystick, a touchpad, and/or a microphone, among others) and a display (e.g., a CRT monitor, an LCD display panel, and/or a speaker, among others). Otherwise, user input may be received via another computer or terminal.

For additional storage, computer 12 may also include one or more mass storage devices 20, e.g., a floppy or other removable disk drive, a hard disk drive, a direct access storage device (DASD), an optical drive (e.g., a CD drive, a DVD drive, etc.), and/or a tape drive, among others. Furthermore, computer 12 may include an interface 24 with one or more networks (e.g., a LAN, a WAN, a wireless network, and/or the Internet, among others) to permit the communication of information with other computers and electronic devices. It should be appreciated that computer 12 typically includes suitable analog and/or digital interfaces between CPU 16 and each of components 18, 20, 22 and 24 as is well known in the art.

In a similar manner to computer 12, computer 14 includes a CPU 26, memory 28, a runtime environment in the form of a JAVA Virtual Machine (JVM) 110, a server 44 (e.g., application server), a computer program 111 or application 111 to be executed in JVM 110, mass storage 30, user interface 32 and network interface 34. However, given the nature of computers 12 and 14 as client and server, in many instances computer 14 will be implemented using a multi-user computer such as a server computer, a midrange computer, a mainframe, etc., while computer 12 will be implemented using a desktop or other single-user computer. As a result, the specifications of the CPU's, memories, mass storage, user interfaces and network interfaces will typically vary between computers 12 and 14. Other hardware environments are contemplated within the context of the invention.

Computers 12, 14 are generally interfaced with one another via a network 36, which may be public and/or private, wired and/or wireless, local and/or wide-area, etc. Moreover, network 36 may represent multiple, interconnected networks. In the illustrated embodiment, for example, network 36 may include the Internet.

Each computer 12, 14 operates under the control of an operating system 38, 40, and executes or otherwise relies upon various computer software applications, components, programs, objects, modules, data structures, etc. (e.g. client 42 and server 44). Moreover, various applications, components, programs, objects, modules, etc. may also execute on one or more processors in another computer coupled to computer 12, 14 via a network, e.g., in a distributed or client-server computing environment, whereby the processing required to implement the functions of a computer program may be allocated to multiple computers over a network.

In general, the routines executed to implement the embodiments of the invention, whether implemented as part of an operating system or a specific application, component, program, object, module or sequence of instructions, or even a subset thereof, will be referred to herein as “computer program code,” or simply “program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable media used to actually carry out the distribution. Examples of computer readable media include, but are not limited to, physical, recordable type media such as volatile and non-volatile memory devices, floppy and other removable disks, hard disk drives, magnetic tape, optical disks (e.g., CD-ROMs, DVDs, etc.), among others, and transmission type media such as digital and analog communication links.

In addition, various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization (e.g., components may be added and/or omitted) and allocation of program functionality described herein.

In the context of the invention, FIGS. 2 and 3 illustrate expanded views 50 and 55 of system 10, during runtime, prior to dynamic proxy object generation and after dynamic proxy object generation. Turning to FIG. 2, as in FIG. 1, a computer program 101 (e.g., client-side of an application) may be executed in runtime environment JVM 100 in client computer 12. During runtime of client 42, illustrated as client runtime 102, a connection 120 may be established between routing service 103 and server runtime 112 of server 44 of server computer 14. Client runtime 102 has a proxy generation mechanism 104 to be utilized to dynamically generate the proxy object after the target object is dynamically created during server runtime 112.

Target object 116 is dynamically created during server runtime 112, for example, when computer program 111 (i.e., server-side of an application) is executed in runtime environment JVM 110. Naming service 113 may be utilized to locate target object 116 and class metadata generation mechanism 114 may be utilized to create class metadata similar to or identical to that of target object 116. The class metadata created by class metadata generation mechanism 114 may then be sent back to client runtime 102 to generate the proxy object.

Turning to FIG. 3, proxy object 105 may be dynamically generated or created by proxy generation mechanism 104 to invoke methods on target object 116, which is dynamically created during server runtime 112. Proxy generation mechanism 104 may create class definitions and add routing code to create proxy object 105. As such, the proxy object will have class definitions that will define the type of the proxy object, and the type of the object may be cast to a type that is specific to computer program 101. The created proxy object 105 also has at least one method 106 and routing code 107 for remote method invocation.

To perform remote method invocation, computer program 101 may invoke method 106 of proxy object 105, method 106 may use routing code 107 to send a method execution request to routing service 103, and routing service 103 may forward the request to proxy method execution request processor 115 in the server runtime 112, as illustrated by arrows 125, 130 and 140, respectively. As such, the proxy object's method 106 invoked by computer program 101 may be executed with the target object 116.

These operations, as well as others described herein, may be performed by a client process associated with client runtime 102 or a server process associated with server runtime 112 depending upon the runtime associated with the operation. Additionally, the items illustrated in FIGS. 2-5 with client runtime 102 and server runtime 112 are meant to indicate that the items are associated with that runtime. However, those of ordinary skill in the art will appreciate that the use of the terminology “client process” and “server process”, or of any of the terminology used, is not meant to limit the principles of the present invention. Indeed, those skilled in the art will recognize that the exemplary environments illustrated in FIG. 1, FIG. 2, and FIG. 3 are not intended to limit the present invention. Those skilled in the art will recognize that other alternative hardware and/or software environments may be used without departing from the scope of the invention.

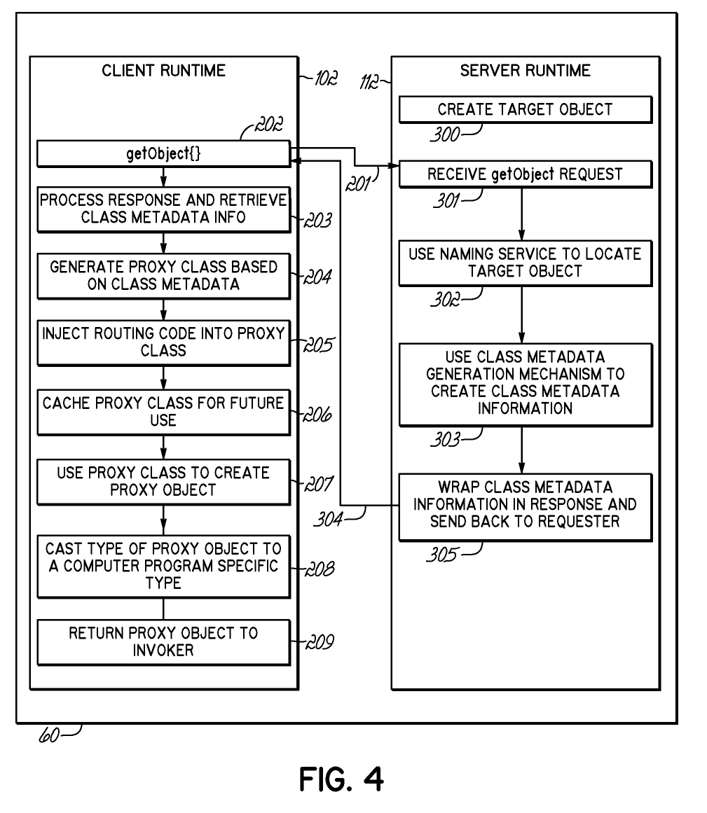

Turning to FIG. 4, FIG. 4 illustrates an exemplary dynamic proxy generation routine 60. In block 300, an object (i.e., target object 116) is dynamically created on the server during server runtime 112. The target object may be created using a configuration object that has class name information, etc. After the target object is created, the object type of the target object will be known by the server process.

In block 202, during client runtime 102, computer program 101 in the client process may issue a getObject command or method to request the object type of the target object from the server process. To carry out the getObject command, middleware from the client-side may contact the server process to return the object type of the target object, as well to return other requisite information. This contact is illustrated by arrow 201 and may be accomplished by using Java introspection. The getObject request is received by the server process in block 301.

The naming service in the server process may be utilized to locate the target object in block 302. After the target object is located, class metadata generation mechanism 114 may be utilized to create the class metadata in block 303. The class metadata may include the class name of the target object, as well as any other information needed for remote method invocation on the target object. The created class metadata information may then be wrapped into a response in block 305 to be returned to the client process. The response may be sent back to the requester (i.e., getObject command) in block 305, which is depicted by arrow 304.

Next, block 203 may process the response and retrieve the class metadata (i.e., the object type of the target object). Those of ordinary skill in the art will appreciate that prior to receiving the class metadata from the server process, the type of the target object was unknown to the client process and to computer program 101.

Next, a proxy class based on the retrieved class metadata may be generated in block 204. The proxy class will serve as a template for the proxy object (i.e., proxy object 105). The proxy class is compatible with the target object. Moreover, the proxy class may be compatible with the expected application specific interfaces of computer program 101 and may be utilized to construct the proxy object. In particular, the proxy generation mechanism may perform byte code manipulation to create a new class definition, for example, in byte[ ] format, based on the retrieved class metadata. The newly create proxy class may then be pushed into the class loader. In some embodiments, an object factory may be created that is capable of creating a proxy object based on the retrieved information. Specifically, the object factory may perform the byte code manipulation using utilities like CGLIB and SERP to create the new class definition for the proxy object. Nonetheless, a class definition may be dynamically created for the proxy object from the retrieved class metadata to define a type for the proxy object.

Next, routing code may be added into the proxy class in block 205. The middleware layer may be utilized to add the client-server routing code. The routing code may be middleware provider specific. Alternatively, if an object factory is utilized, the object factory may add the client-server routing code. Block 70 of FIG. 6 illustrates an example of routing code that may be added or injected. The routing code may be utilized to route method invocations to the target object. The proxy class may be cached for future use in a cache (not shown) of the client computer in block 206.

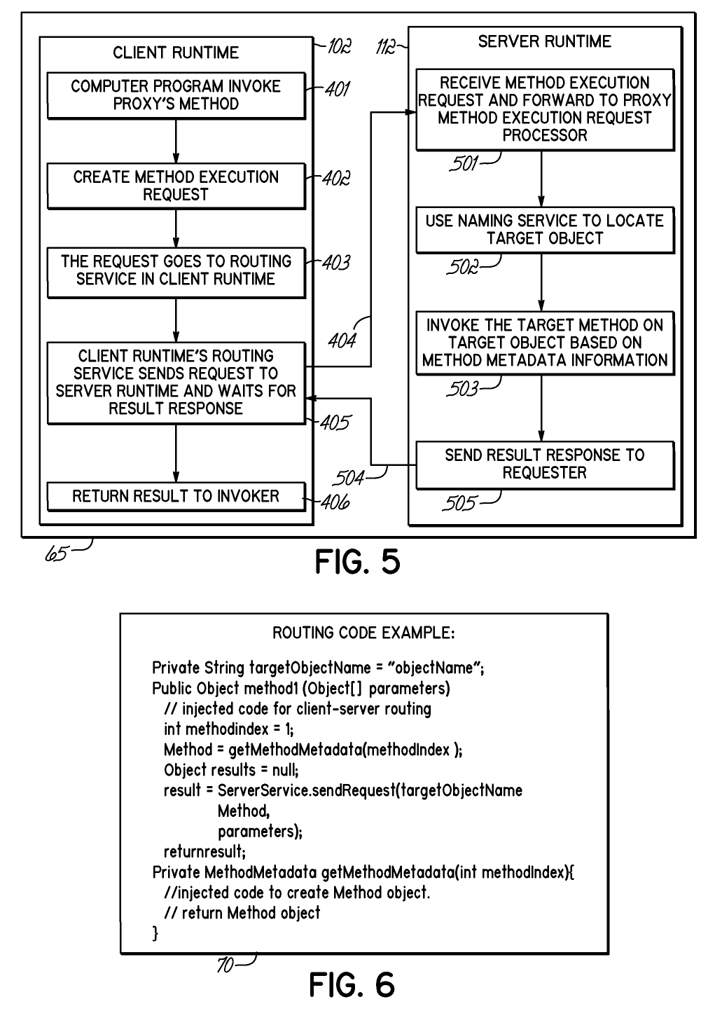

Next, the proxy class may be used to generate the proxy object in block 207. The proxy object may be dynamically created locally in the client computer during client runtime and is bound to the target object on the server computer. Furthermore, as the retrieved class metadata was utilized to create the proxy class definition, the created client-side proxy object is a sub-type of the type of the target object. The proxy object and the target object are also compatible and as such, the proxy object may be utilized to route requests for execution on the target object. In particular, methods of the proxy object may be invoked by computer program 101 and the method invocations may be routed to the target object on the server computer for execution on the target object. The result of the execution on the target object will be returned back to the client process for forwarding to the invoker (e.g., computer program 101). This will be discussed further in connection with FIG. 5.

Next, in block 208, the type of the created proxy object defined by the proxy class may be cast to a different type, such as a type that a specific to computer program 101. Specifically, computer program 101 may cast the type of the proxy object to a type that is known to the computer program 101 and invoke its methods. The proxy object may be cast to an application-specific interface so that methods defined in that interface may be invoked. As such, the APIs of that type may be directly utilized. The proxy object may be returned to the invoker (e.g., computer program 101) in block 209.

Those of ordinary skill in the art may appreciate that by casting the type of the created proxy object to a type that is specific to computer program 101, computer program 101 may interact with the proxy object as if it were interacting directly with the target object on the server computer. Moreover, this may provide a client-side handle that is compatible with the target object on the server computer. Nonetheless, even after casting, the method invocations will be routed to the target object on the server computer.

Next, FIG. 5 illustrates an exemplary remote method invocation routine 65. Computer program 101 may invoke a method (i.e., method 106) of the created proxy object in block 401 during client runtime 102. The proxy object will recognize which method was invoked by computer program 101, as well as any passed parameters.

A method execution request may then be created in block 402 to send the execution of the invoked proxy object's method to the target object on the server computer. The method execution request may be constructed via the client-side middleware layer. The request may include method metadata such as, but not limited to, the name of the target object, the method, and parameters. In particular, the method execution request may include all information about the invocation of the proxy object's method and may be utilized to construct a method object in the server process for the execution on the target object.

The request may be sent to the server process by routing service 103 in block 403. The routing service may utilize the routing code to send the method execution request to the server process. Arrow 404 is meant to illustrate that the method execution request is sent to the server. The routing service will wait for a result response from the server process.

The method execution request is received by the server process and forwarded to a proxy method execution request processor 115 in block 501. Naming service 113 may be utilized to locate the target object in block 502. In particular, the server process usually catalogs objects, for example, by name or by other conventional techniques, and as such, the server-side object that is the target object may be located.

Next, in block 503, after the target object is located, the target method may be invoked on the target object based on the method metadata from the proxy's method received from the method execution request. To invoke the target method, a local method object with the same configurations as the one in the client process may be created. As such, the created method object with the passed parameters may be invoked on the target object to generate a result. A result response may be sent to the requester in the client process in block 505. This transmission is illustrated by arrow 504.

Next, in block 405, the result response is received and returned to the invoker in block 406. In particular, the routing service may forward the result to the proxy object and the proxy object may then return the result to computer program 101.

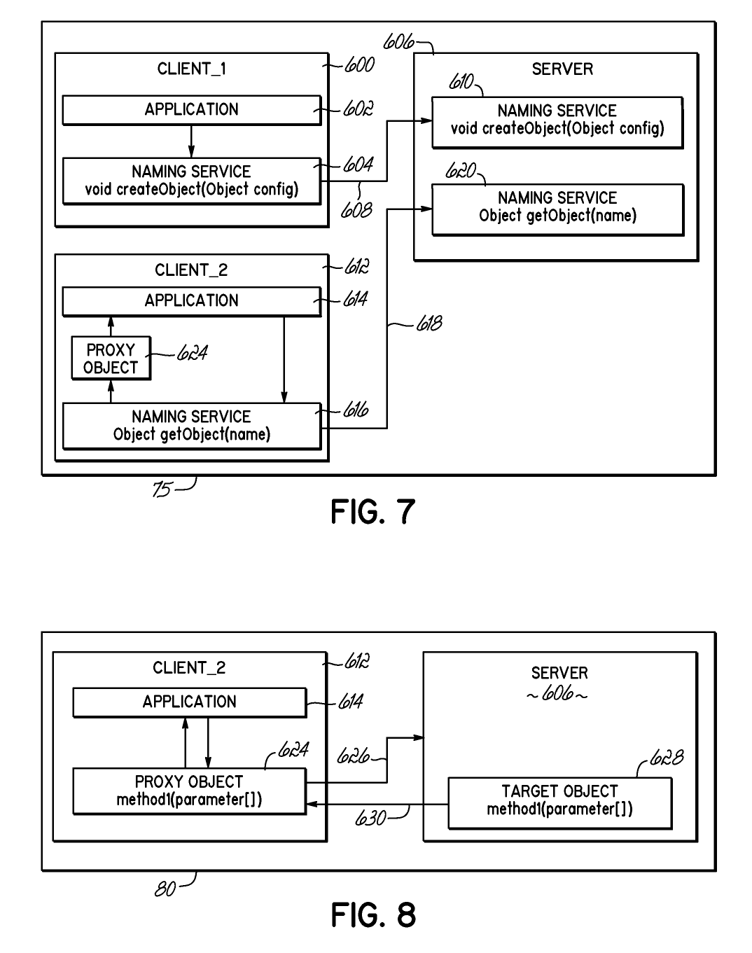

Turning next to FIG. 7, FIG. 7 is a block diagram illustrating an example 75 of dynamic proxy object generation in an environment with two clients and one server. Specifically, an application 602 associated with client_1 process 600 may issue a create object command with a configuration object, for example, utilizing naming service 604. The command may be transmitted, as illustrated by arrow 608, to server process 606. As such, an object may be dynamically created during server runtime on the server. Specifically, server process 606 may create the server-side object (i.e., target object 628 shown in FIG. 8) with naming service 610.

Next, a separate application 614 associated with a separate client_2 process 612 may issue a getObject(name) command to obtain a client-side handle (i.e., the proxy object) that is bound to the newly created object instance (i.e. the target object) on the server. The command may be transmitted, as illustrated by arrow 618, to naming service 620 in server process 606. Upon receiving the type of the target object, proxy object 624 may be dynamically generated based on that type in the client_2 process 612. Furthermore, the type of the proxy object may be cast to a type that is specific to application 614. For instance, the type of the proxy object may be cast to an application 614 specific type so that application 614 can deal with application-specific interfaces transparently in this client-server environment. Once created, proxy object 624 may be provided to application 614 so that application 614 may invoke the methods of the proxy object.

FIG. 8 is a block diagram illustrating example 80 of remote method invocation, which is a continuation of example 75. Specifically, application 614 associated with client_2 process 612 may invoke a method of proxy object 624 such as a method1(parameter [ ]). Specifically, application 614 may invoke a method of the proxy object defined in the interface. The invocation will be transmitted via arrow 626 to server process 606 to be executed on target object 628. The results will be forwarded back to client_2 process 612 and then to proxy object 624 via arrow 630. Proxy object 624 will forward the results to application 614.

Those of those of ordinary skill in the art may appreciate that via the exemplary embodiments described herein, remote server-side object method invocation of server-side objects that are dynamically created may be accomplished. Furthermore, a compatible handle that is of a type that is application specific, which may not be known to the rest of the system, may be created. In particular, a generic mechanism to generate application-specific interface type client-side proxies for server-side objects with unknown types that are dynamically created during runtime is provided. As such, from the middleware perspective, a proxy object (i.e., handle) may be provided that is of a type of the user provided interface or a subclass to avoid creating errors such as ClassCastException errors, despite the dynamically created server-side objects.

Moreover, the embodiments describe herein may provide a simpler programming model as applications can deal with application-specific interfaces transparently in the client-server environment. In particular, the server-side of the application can register an object dynamically and make it available to all clients. On the other hand, the client-side application can perform regular lookup operations for a cataloged server-side object and cast it to an application-specific interface, and invoke methods defined in that interface. Those of ordinary skill in the art may appreciate that this may be desirable because it makes the application follow API contracts instead of reflection, which is sometimes error prone, because incorrect usage may not be detected at compile time. Furthermore, this may make it easier to migrate and/or reuse the applications. For example, a single application may be written to work with a proxy object irrespective of how a proxy object may be created.

Those of ordinary skill in the art may also appreciate that the embodiments discussed herein are protocol independent, may reduce the overhead on the server as many of the operations are completed in the client process (e.g., creating a proxy class and creating a proxy object), do not require a deployment process or code generation during compilation or at runtime, and simplify application management as all operations may be done during client or server runtime. Although the operations are performed during runtime, a costly server-side runtime deployment process, which likely supports only one or a few protocols, is not needed. Moreover, any performance impact with the embodiments herein will generally be lower than it would be with the deployment process. Additionally, the middleware has the flexibility to process routing more efficiently and routing described herein includes routing code that is protocol independent, added to the proxy object, and provided by the middleware layer.

Various modifications may be made to illustrated embodiments without departing from the spirit and scope of the invention. Therefore, the invention lies in the claims hereinafter appended.

What is claimed is:

1. A method of executing a computer program resident on a client, the method comprising, during execution of the computer program by the client:
in the client, retrieving class metadata of an object that is used by the computer program from a remote service, including retrieving object type data of the object, wherein the object is dynamically created and resides on a server, and wherein the type of the object is unknown to the computer program prior to retrieval of the class metadata; and
dynamically generating on the client a proxy object for the object on the server using the retrieved class metadata.

2. The method of claim 1, wherein dynamically generating the proxy object includes dynamically creating a class definition for the proxy object from the retrieved class metadata to define a type for the proxy object.

3. The method of claim 2, wherein the type of the proxy object and the type of the object that resides on the server are compatible.

4. The method of claim 2, wherein the type of the proxy object is a sub-type of the type of the object that resides on the server.

5. The method of claim 2, wherein the type of the proxy object is compatible with at least a portion of the computer program in the client.

6. The method of claim 2, further comprising casting the type of the proxy object to a type that is based upon the computer program in the client.

7. The method of claim 6, wherein casting the type of the proxy object further comprises casting to a type that is specific to an interface known to the computer program.

8. The method of claim 1, further comprising invoking at least one method of the proxy object by the computer program.

9. The method of claim 8, further comprising executing the method with the object that resides on the server.

10. The method of claim 9, further comprising receiving in the client a result from the object that resides on the server based upon the executed method.

11. The method of claim 9, wherein in executing the method with the object that resides on the server further comprises creating a method object on the server utilizing metadata from the method and invoking the method object on the object that resides on the server.

12. The method of claim 1, wherein dynamically generating the proxy object includes adding client-server routing code into the proxy object.

13. An apparatus comprising:
a processor,
a memory; and
program code resident in the memory and configured to be executed by the processor to execute a computer program resident on a client by retrieving class metadata of an object that is used by the computer program from a remote service, including retrieving object type data of the object, wherein the object is dynamically created and resides on a server, and wherein the type of the object is unknown to the computer program prior to retrieval of the class metadata, and dynamically generating on the client a proxy object for the object on the server using the retrieved class metadata.

14. The apparatus of claim 13, wherein the program code is further configured to dynamically generate the proxy object by dynamically creating a class definition for the proxy object from the retrieved class metadata to define a type for the proxy object.

15. The apparatus of claim 14, wherein the type of the proxy object and the type of the object that resides on the server are compatible.

16. The apparatus of claim 14, wherein the type of the proxy object is a sub-type of the type of the object that resides on the server.

17. The apparatus of claim 14, wherein the type of the proxy object is compatible with at least a portion of the computer program in the client.

18. The apparatus of claim 14, wherein the program code is further configured to cast the type of the proxy object to a type that is based upon the computer program in the client.

19. The apparatus of claim 18, wherein the program code is further configured to cast the type of the proxy object by casting to a type that is specific to an interface known to the computer program.

20. The apparatus of claim 13, wherein the program code is further configured to invoke at least one method of the proxy object by the computer program.

21. The apparatus of claim 20, wherein the program code is further configured to initiate execution of the method with the object that resides on the server.

22. The apparatus of claim 21, wherein the program code is further configured to receive in the client a result from the object that resides on the server based upon the executed method.

23. The apparatus of claim 21, wherein the program code is further configured to initiate execution of the method with the object that resides on the server by initiating creation of a method object on the server utilizing metadata from the method and initiating invocation of the method object on the object that resides on the server.

24. The apparatus of claim 13, wherein the program code is further configured to dynamically generate the proxy object by adding client-server routing code into the proxy object.

25. A program product, comprising:
program code configured to execute a computer program resident on a client by retrieving class metadata of an object that is used by the computer program from a remote service, including retrieving object type data of the object, wherein the object is dynamically created and resides on a server, and wherein the type of the object is unknown to the computer program prior to retrieval of the class metadata, and dynamically generating on the client a proxy object for the object on the server using the retrieved class metadata; and
a computer readable medium bearing the program code.
